(19) United States
(12) Patent Application Publication
(10) Pub. No.: US 2026/0087352 A1
(43) Pub. Date: Mar. 26, 2026

(54) AI-POWERED ADAPTABLE DRIFT MANAGEMENT SYSTEM FOR COMPUTER SERVERS

(71) Applicant: BANK OF AMERICA CORPORATION, Charlotte, NC (US)

(72) Inventors: Amer Ali, Jersey City, NJ (US); Mohammad Saleem Gaziani, Plano, TX (US); Aaron Gee, Palm Coast, FL (US); Aisha Jenkins, Atlanta, GA (US); John Lozes, Wilmington, DE (US); Tonya Kyra Miller, Charlotte, NC (US); Manonmani Palanichamy, Fort Mill, SC (US); Naresh Kumar Petapalle, Welling, Kent (GB); Aravind Singtalur, McKinney, TX (US); Pramod Bhadravathi Srinivasa, Bear, DE (US); Asha Thekkumpurath, Frisco, TX (US); Andrea M. Weisberger, Jacksonville, FL (US)

(73) Assignee: BANK OF AMERICA CORPORATION, Charlotte, NC (US)

(21) Appl. No.: 18/897,317

(22) Filed: Sep. 26, 2024

(51) Int. Cl. G06N 3/09; G06F 16/11; G06N 3/084

(52) U.S. Cl. CPC G06N 3/09; G06F 16/116; G06N 3/084

(57) ABSTRACT

Systems, computer program products, and methods are described herein for an AI-powered adaptable drift management system for computer servers. The present invention is configured to retrieve a server template of a server; extract template parameter values from the server template; extract data for a current server configuration of the server; generate server parameter values from the data or via feature engineering of the data; convert the generated server parameter values into a formatted file; transmit the formatted file; receive an additional formatted file containing deviated parameter values; analyze server performance under combinations of the deviated parameter values and the template parameter values; identify a combination of parameter values that optimizes server performance; adjust the server configuration using the identified combination parameter values; update the server template with the identified combination of parameter; transmit the updated server template; and transmit a report of the updates to the server template.

### FIELD OF THE INVENTION

The present invention embraces a system for an AI-powered adaptable drift management system for computer servers.

### BACKGROUND

Traditional drift management systems maintain server configurations by comparing current settings to a predefined state and reverting any deviations to the predefined state. Such rigid adherence to the predefined state may result in suboptimal performance, increased downtime, and the need for frequent manual interventions to update configurations.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for an AI-powered adaptable drift management for computer servers may include at least one memory device with computer-readable program code stored thereon and at least one processing device operatively coupled to the at least one memory device. In some embodiments, executing the computer-readable code may be configured to cause the at least one processing device to retrieve a server template of a server from the at least one memory device, extract template parameter values from the server template, extract hardware data, resource usage data, metrics data, and performance data for a current server configuration of the server, generate server parameter values from the extracted hardware data, the extracted resource usage data, the extracted metrics data, and the extracted performance data or via feature engineering of the extracted hardware data, the extracted resource usage data, the extracted metrics data, and the extracted performance data, convert the generated server parameter values into a formatted file, transmit the formatted file, receive an additional formatted file containing deviated parameter values, analyze server performance under combinations of the deviated parameter values and the template parameter values, identify a combination of the server parameter values and the deviated parameter values that optimizes server performance, adjust the server configuration using the identified combination of the server parameter values and the deviated parameter values that optimize server performance, update the server template with the identified combination of the server parameter values and the deviated parameter values that optimizes server performance, transmit the updated server template and transmit a report of the updates to the server template.

In some embodiments, an external database may be configured to receive and store the formatted file, and the external database may be operatively coupled to an engine configured to receive the formatted file from the external database, extract the generated server parameter values from the formatted file, retrieve the template parameter values from the external database, compare the template parameter values and the generated server parameter values to identify deviations between the template parameter values and the server parameter values, create the additional formatted file containing the deviated parameter values, and return the additional formatted file.

In some embodiments, the system may include an AI model configured to request historical data of the server from the external database, receive historical data of the server, analyze the historical data in conjunction with the extracted hardware data, the extracted resource usage data, the extracted metrics data, and the extracted performance data to extract trends in the performance of the server, generate future parameter values based on the trends that will optimize the server performance and transmit a notification of recommended future parameter values.

In some embodiments, the external database may be configured to receive the updated server template and update the current template parameter values with the updated template parameter values of the updated server template. Additionally, or alternatively, the system may include an AI model configured to input a combination of the template parameter values and the deviated parameter values on a test server, run the test server under the combination, monitor the performance of the test server under the combination, extract hardware data, resource usage data, metrics data, and performance data for the test server under the combination, generate an overall performance metric for the test server under the combination, compare the overall performance metric against a previous overall performance metric, store the better performing of the overall performance metric and the previous overall performance metric, and repeat for a new combination of the template parameter values and the deviated parameter values.

In some embodiments, the AI model may be configured to transmit and receive instructions from the DevOPs tools and to automate DevOPs processes.

In some embodiments, executing the computer-readable code may be configured to cause the at least one processing device to, before adjusting the server configuration determine if changes to the server configuration caused by adjusting the server configuration using the identified combination of the server parameter values and the deviated parameter values that optimize server performance satisfy a threshold, if the changes satisfy the threshold, request administrator authorization to update the server configuration and the server template, and if the changes do not satisfy the threshold, update the server configuration and the server template automatically.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of an AI-powered adaptable drift management system for computer servers, in accordance with an embodiment of the disclosure;

FIG. 2 illustrates an exemplary architecture of an artificial intelligence (AI) engine subsystem, in accordance with an embodiment of the disclosure;

FIGS. 3A and 3B illustrate a process flow for AI-powered adaptable drift management for computer servers, in accordance with an embodiment of the disclosure;

FIG. 4 illustrates a process flow for AI-powered adaptable drift management for computer servers, in accordance with an embodiment of the disclosure;

FIG. 5 illustrates another process flow for AI-powered adaptable drift management for computer servers, in accordance with an embodiment of the disclosure;

FIG. 6 illustrates another process flow for AI-powered adaptable drift management for computer servers, in accordance with an embodiment of the disclosure; and

FIG. 7 illustrates another process flow for AI-powered adaptable drift management for computer servers, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present disclosure provides an AI-powered drift management system for computer servers. In an example embodiment, the invention discloses a system that may include an artificial intelligence (AI) model configured to extract data (e.g., hardware data, resource usage data, metrics data, performance data, and/or the like) for a current server configuration. Further, the AI model may generate new data via manipulations of the extracted data (e.g., feature engineering). Additionally, or alternatively the system may include an external database that may be operatively coupled to an engine, where the engine may be configured to compare and identify deviations between parameter values of the current server configuration and template parameter values (e.g., parameter values associated with a predetermined state for a server configuration). In some embodiments, the system may include a plurality of additional AI models configured to conduct predictive analytics (e.g., generate insights via calculations of how a server configuration may perform in the future based on historical data) and/or simulate a set of parameter values for a server configuration to test the overall performance of the set of parameter values.

Traditional drift management systems maintain server configurations by comparing current settings to a predefined state and reverting any deviations to the predefined state. However, this static approach fails to account for evolving operational requirements and dynamic changes in the computing environment. Over time, various configurations may need to adapt to new values due to increased workload, software updates, security patches, or other factors. Rigid adherence to the predefined state can result in suboptimal performance, increased downtime, and the need for frequent manual interventions to update configurations.

Embodiments of the present disclosure may leverage an AI-powered adaptable drift management system that detects and remediates configuration drifts. Further, the system may use artificial intelligence (AI) to learn, suggest, and/or implement necessary configuration changes. Additionally, or alternatively, the system may dynamically adapt server configurations to meet evolving requirements while updating a predefined state for the server configuration to reflect optimal settings.

In some embodiments, an AI-powered adaptable drift management system for computer servers may be configured to constantly monitor server configurations, comparing them to the current predefined state and identifying any drifts. Further, the system may leverage AI algorithms to analyze detected drifts, considering factors such as workload patterns, performance metrics, and security requirements. Additionally, or alternatively, the system may be configured to automatically adjust server configurations to optimal settings based on AI insights, rather than simply reverting to the original predefined state.

In some embodiments, the system may update predefined state with new optimal configurations learned through AI analysis, ensuring it evolves with changing requirements. Further, the system may be configured to provide configuration change recommendations (e.g., a recommendation engine) for temporary and/or permanent drift based on predictive analytics and historical data. Additionally, or alternatively, the system may be configured to alert administrators to significant changes and may allow for manual approval of critical updates, maintaining control over the adaptation process.

In some embodiments, the system may be integrated with existing DevOps and configuration management tools to streamline the implementation of configuration changes. Further, the system may be configured to ensure all changes comply with security policies and regulatory standards, maintaining a secure and compliant environment. As will be appreciated by one of ordinary skill in the art in view of the present disclosure, embodiments of the present disclosure may revolutionize traditional drift management by introducing intelligent, adaptive, and/or proactive configuration management, ensuring optimal server performance and responsiveness to changing requirements without the need for constant manual intervention.

Accordingly, the present invention includes a system, computer program, and/or method for using AI to manage computer server drift. Embodiments of the present disclosure may include a plurality of artificial intelligence (AI) models configured to monitor, analyze, and update computer server configurations and computer server templates to an optimized state. In an example embodiment, an AI model may be configured to extract data (e.g., hardware data, resource usage data, metrics data, performance data, and/or the like) for a current server configuration. Further, the AI model may be configured to generate server parameter values from the extracted data or via feature engineering of the extracted data and generate a formatted file of the server parameter values. Additionally, an external database may be configured to receive and store the formatted file, and the external database may be operatively coupled to an engine configured to compare the template parameter values and the generated server parameter values to identify deviations between the parameters.

In some embodiments, an AI model may be configured to analyze server performance under combinations of the deviated parameter values and the template parameter values to identify a combination parameter values that optimizes server performance. Further, the AI model may be configured to update the server template with the identified combination that optimizes server performance. Additionally, an AI model may be configured to analyze historical data in conjunction with the extracted data to extract trends in the performance of the server and generate future parameter values based on the trends that may optimize the server performance. In some embodiments, a single AI model may be configured to perform some and/or all the aforementioned steps. In some embodiments, a plurality of AI models may be configured to perform some and/or all of the aforementioned steps.

What is more, the present invention provides a technical solution to a technical problem. As described herein, the technical problem includes proactively managing drift in a server from a predefined state and continuously optimizing the predefined state. The technical solution presented herein allows for AI models to monitor the server configuration, detect drifts in the server configuration from a predefined state, adjust the server configuration to match the predefined state, and/or optimize the predefined state. In particular, the AI-powered adaptable drift management system is an improvement over existing solutions to manage drift in a server from a predefined state, (i) with fewer steps to achieve the solution, thus reducing the amount of computing resources, such as processing resources, storage resources, network resources, and/or the like, that are being used (e.g., by predictively adapting to changing loads on the servers over reverting to old configurations incapable of handling the changed loads until human intervention recognizes the changed loads and updates the configurations, the system may reduce the number of steps needed), (ii) providing a more accurate solution to problem, thus reducing the number of resources required to remedy any errors made due to a less accurate solution (e.g., by leveraging AI models, the system may quickly and accurately detect and remedy drifts in a current server configuration from a predefined state), (iii) removing manual input and waste from the implementation of the solution, thus improving speed and efficiency of the process and conserving computing resources (.e.g., by leveraging AI models, the system may eliminate the need for manual correction of server configuration drift), (iv) determining an optimal amount of resources that need to be used to implement the solution, thus reducing network traffic and load on existing computing resources solution (e.g., by leveraging AI models in predictive analytics, the system may continuously update and/or make recommendations of updates to optimize the performance of a predefined state for a server configuration such that the amount of resources used by the server is minimized). Furthermore, the technical solution described herein uses a rigorous, computerized process to perform specific tasks and/or activities that were not previously performed. In specific implementations, the technical solution bypasses a series of steps previously implemented, thus further conserving computing resources.

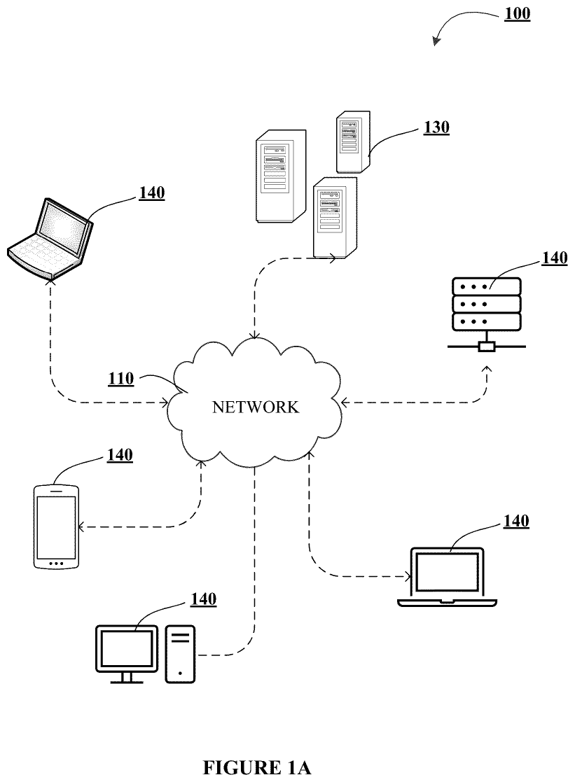

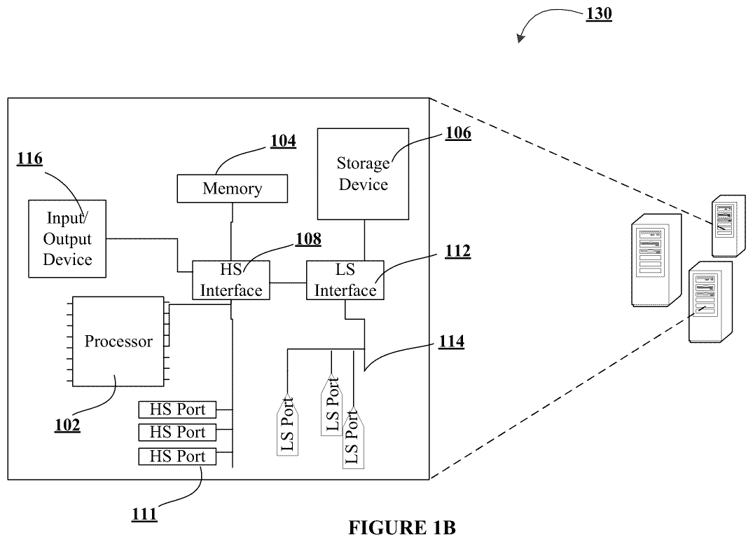

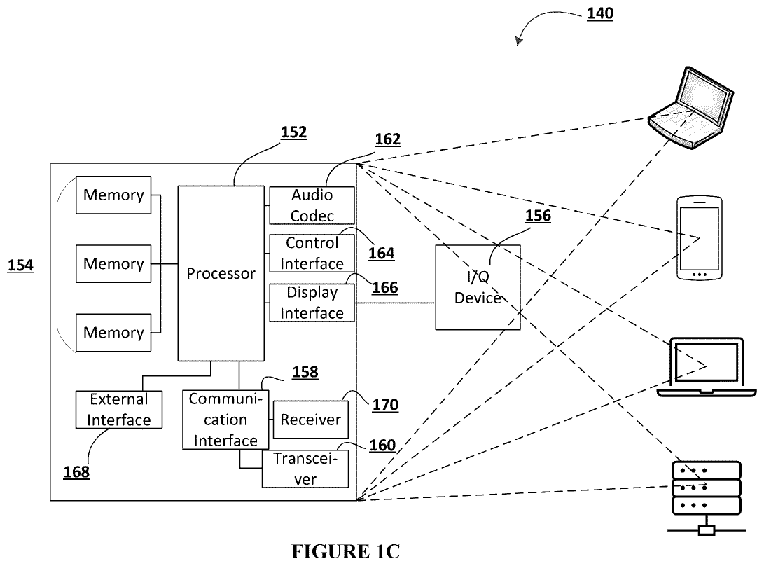

FIGS. 1A-1C illustrate technical components of an AI-powered adaptable drift management system for computer servers, in accordance with an embodiment of the invention. As shown in FIG. 1A, the distributed computing environment 100 contemplated herein may include a system 130 (e.g., an adaptable drift management system), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

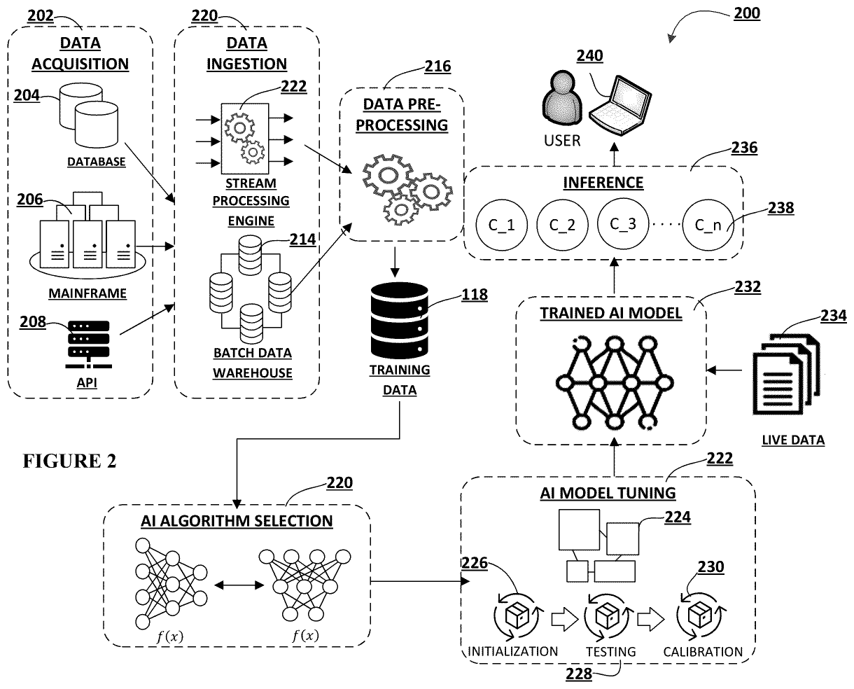

FIG. 2 illustrates an exemplary architecture of an artificial intelligence (AI) engine subsystem 200, in accordance with an embodiment of the disclosure. In some embodiments, the AI engine subsystem 200 may be included in a system (e.g., similar to the system 130 shown and described herein with respect to FIGS. 1A-1C, an AI-powered adaptable drift management system, and/or the like). Additionally, or alternatively, the AI engine subsystem 200 may be a subsystem of another system (e.g., similar to the system 130 shown and described herein with respect to FIGS. 1A-1C) that is in communication with an AI-powered adaptable drift management system (e.g., via a network similar to the network 110 as shown and described herein with respect to FIGS. 1A-1C). The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

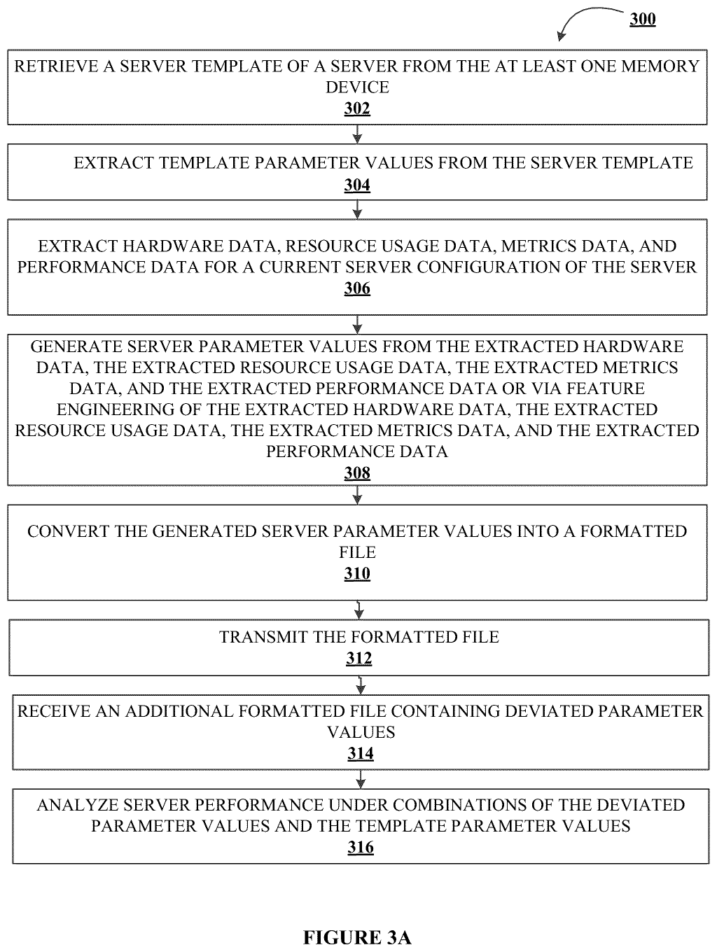

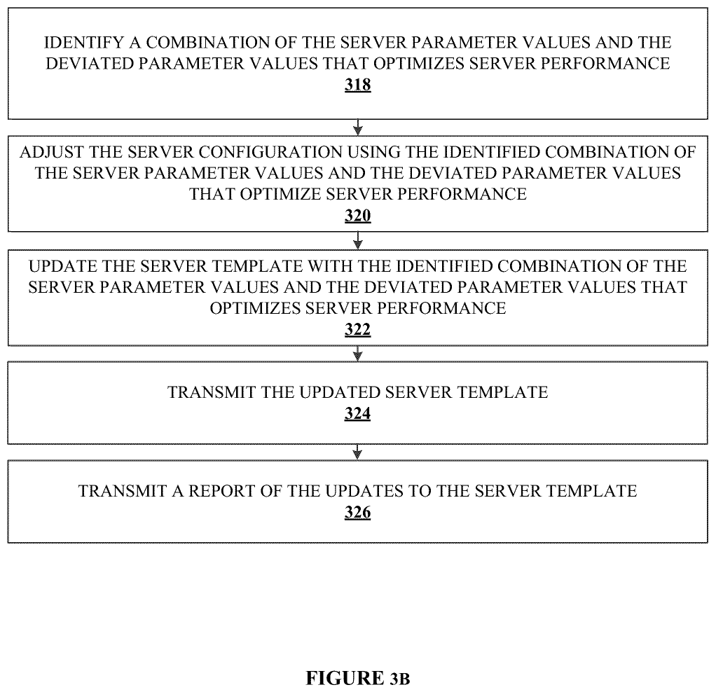

FIGS. 3A and 3B illustrate a process flow 300 for AI-powered adaptable drift management for computer servers, in accordance with an embodiment of the disclosure. In some embodiments, a system (e.g., similar to one or more of the systems shown and described herein with respect to FIGS. 1A-1C) may perform one or more of the steps of process flow 300. For example, an AI-powered adaptable drift management system (e.g., similar to the system 130 shown and described herein with respect to FIG. 1A-1C) may perform one or more of the steps of process flow 300. In some embodiments, an artificial intelligence engine (e.g., similar to the AI engine subsystem 200 as shown and described herein with respect to FIG. 2) may perform one or more of the steps of process flow 300.

As shown in block 302 of FIG. 3A, the process flow 300 may include the step of retrieving a server template of a server. In some embodiments, the server template (e.g., a template of parameters values for a predefined state a server should be configured to be in) may be stored in a memory device (e.g., a database). Further, the server template and/or a copy of the server template may be transmitted from the location of the server template to an AI model upon need for use in analysis. In some embodiments, the server template may be stored in a single memory device and/or in a plurality of memory devices (e.g., external databases).

As shown in block 304 of FIG. 3A, the process flow 300 may include the step of extracting template parameter values from the server template. In some embodiments, the server template may include a plurality of parameters that may define how a server operates (e.g., memory usage, hardware usage, performance values, speed values, location values, and/or the like). Further, the AI model may extract (e.g., store a copy of a parameter in another memory location) any number of the plurality of parameters for use in a calculation of the AI model.

As shown in block 306 of FIG. 3A, the process flow 300 may include the step of extracting hardware data, resource usage data, metrics data, and performance data for a current server configuration of the server. In some embodiments, data related to the server (e.g., the aforementioned hardware data, resource usage data, metrics data, and/or performance data) may be generated by various devices associated with the server (e.g., a percentage of memory used by a memory resource, an amount of power being used by a CPU device, heat being generated by a CPU device, a data transfer rate of a communications device, and/or the like). Further, the AI model may be configured to extract any amount and/or combination of the server related data as needed.

As shown in block 308 of FIG. 3A, the process flow 300 may include the step of generating server parameter values from the extracted hardware data, the extracted resource usage data, the extracted metrics data, and the extracted performance data or via feature engineering of the extracted hardware data, the extracted resource usage data, the extracted metrics data, and the extracted performance data. In some embodiments, a server configuration may include server parameter values that modify the behaviors of the server and/or elements of the server. Further, the server parameter values may be generated directly from the extracted data related to the server. Additionally, or alternatively, the server parameter values may be generated by manipulations of the extracted data (e.g., feature engineering where two or more variables are combined and/or manipulated (e.g., mathematical operations) to create a new variable).

As shown in block 310 of FIG. 3A, the process flow 300 may include the step of converting the generated server parameter values into a formatted file. In some embodiments, the server parameter values may use a large amount of memory resources. In such embodiments, a formatted filed (e.g., a compressed file containing the same information using less memory resources) may be used to store the server parameter values. In some embodiments, the formatted file may be generated by using a compression algorithm (e.g., text compression, lossless compression, lossy compression, run length encoding, dictionary coding, and/or the like) on the server parameter values.

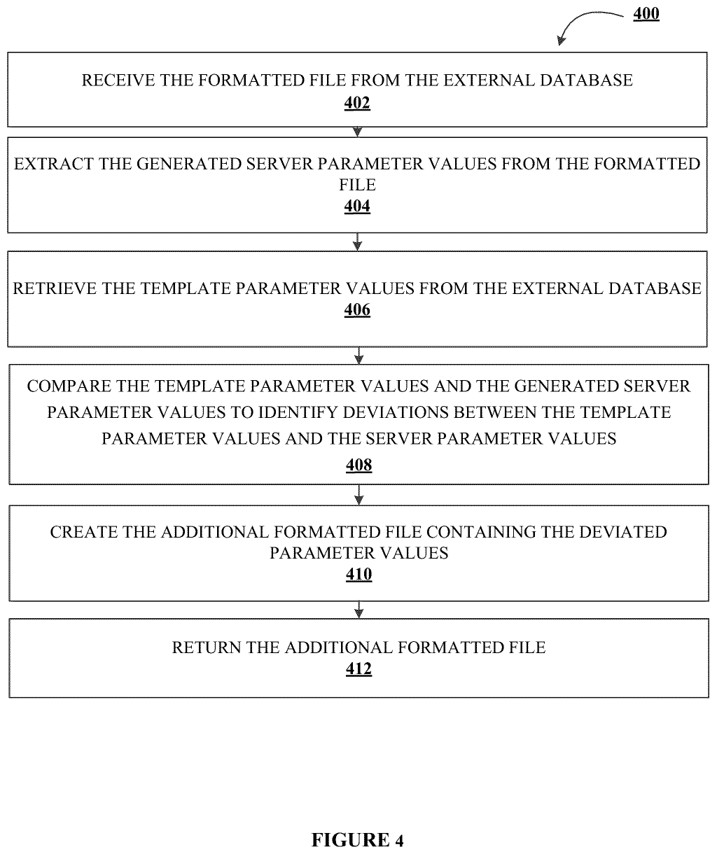

As shown in block 312 of FIG. 3A, the process flow 300 may include the step of transmitting the formatted file. In some embodiments, the formatted file may be sent (e.g., electronically, optically, digitally, mechanically, and/or the like) to an additional data repository (e.g., an external database). Further, the formatted file may be stored in the additional data repository for a temporary period of time and/or an indefinite period of time. Additionally, or alternatively, the formatted file may be required for analysis by a processing device (e.g., an engine, a CPU, an AI model, an ML model, and/or the like). In some embodiments, the step of block 312 may be followed by a step of a block 402 as shown and described herein with respect to FIG. 4.

As shown in block 314 of FIG. 3A, the process flow 300 may include the step of receiving an additional formatted file containing deviated parameter values. In some embodiments, the additional formatted file may be generated by comparison of current parameter values and template parameter values (e.g., deviated parameter values). For example, an engine may be configured to receive files including server parameter values and/or server template values. The engine may analyze the files including these values and compare equivalent parameter values between different files for deviations (e.g., compare a parameter associated with the memory usage of an element of the server for differences in the memory usage). In some embodiments, the step of block 314 may followed a step of a block 412 as shown and described herein with respect to FIG. 4.

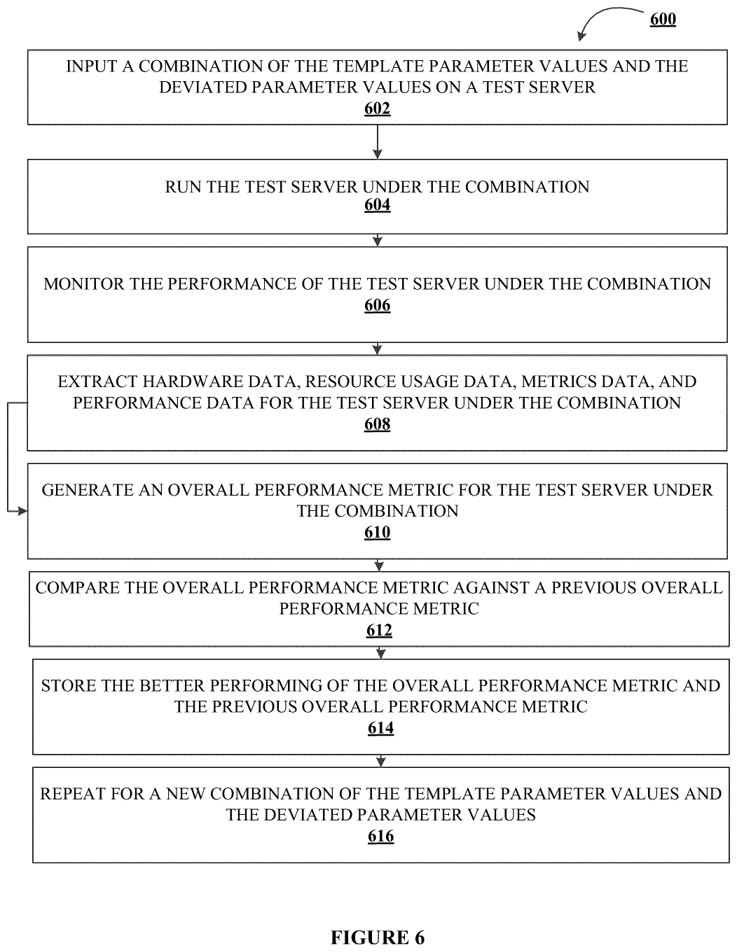

As shown in block 316 of FIG. 3A, the process flow 300 may include the step of analyzing server performance under combinations of the deviated parameter values and the template parameter values. In some embodiments, a server may function differently for a given combination of parameter values. Further, there may exist a plurality of combinations for a given amount of deviated parameter values. In some embodiments, a possible combination of the deviated parameter values and the template parameter values may be simulated to test for server performance under the possible combination. Additionally, or alternatively, another possible combination may be simulated to test for server performance. In some embodiments, the step of block 316 may be performed by the process flow 600 as shown and described herein with respect to FIG. 6.

As shown in block 318 of FIG. 3B, the process flow 300 may include the step of identifying a combination of server parameter values and deviated parameter values that optimizes server performance. In some embodiments, a server may function differently for a given combination of parameter values. Some combinations of parameter values may result in a degradation in overall server performance as compared to the overall performance under template parameter values. Further, some combinations of parameter values may result in an increase in overall server performance as compared to the overall performance under template parameter values. For example, a given set of parameter values may result in a set of server improvements (e.g., reduced memory usage, faster transfer rates, lower power consumption, lower heat generation, and/or the like) that may yield a higher metric (e.g., a calculation including individual performance metrics) of overall server performance.

As shown in block 320 of FIG. 3B, the process flow 300 may include the step of adjusting the server configuration using the identified combination of the server parameter values and the deviated parameter values that optimize server performance. In some embodiments, a combination of server parameters may be identified as performing more optimally than other combinations (e.g., simulations run on the combination of server parameters yield results showing the combination of server parameters performs more optimally than other combinations). In such an embodiment, a server may be updated such that the parameters of the server match the combination of server parameters.

As shown in block 322 of FIG. 3B, the process flow 300 may include the step of updating the server template with the identified combination of the server parameter values and the deviated parameter values that optimizes server performance. In some embodiments, a combination of server parameters may be identified as performing more optimally than other. In such an embodiment, a server template may be updated such that the parameters of the server template match the combination of server parameters that optimize server performance (e.g., the predefined state for a server now includes the optimized server parameters).

As shown in block 324 of FIG. 3B, the process flow 300 may include the step of transmitting the updated server template. In some embodiments, the server template may be stored in a plurality of memory locations (e.g., internal databases, external databases, and/or the like). Further, for each memory location, the updated server template may be received and stored in that memory location. Additionally, or alternatively, the old server template may be overwritten by the updated server template in a memory location. In some embodiments, a copy of the older server template may be kept in at least one memory location.

As shown in block 326 of FIG. 3B, the process flow 300 may include the step of transmitting a report of the updates to the server template. In some embodiments, a report including each updated server parameter may be generated. Further, the report may be transmitted as an alert (e.g., an administrator is notified of the changes to the server parameters). Additionally, or alternatively, a copy of the report may be stored in at least one memory location.

The process flow 300 may include additional embodiments, such as any single embodiment or any combination of embodiments described herein. Although FIGS. 3A and 3B show example blocks of the process flow 300, in some embodiments, the process flow 300 may include additional blocks, fewer blocks, different blocks, or differently arranged blocks than those depicted in FIGS. 3A and 3B. Additionally, or alternatively, two or more of the blocks of the process flow 300 may be performed in parallel.

FIG. 4 illustrates a process flow 400 for AI-powered adaptable drift management for computer servers, in accordance with an embodiment of the disclosure. In some embodiments, a system (e.g., similar to one or more of the systems shown and described herein with respect to FIGS. 1A-1C) may perform one or more of the steps of process flow 400. For example, an AI-powered adaptable drift management system (e.g., similar to the system 130 shown and described herein with respect to FIG. 1A-1C) may perform the steps of process flow 400. In some embodiments, an artificial intelligence engine (e.g., similar to the AI engine subsystem 200 as shown and described herein with respect to FIG. 2) may perform one or more of the steps of process flow 400.

In some embodiments, and as shown in block 402, the process flow 400 may include the step of receiving the formatted file from the external database. In some embodiments, an engine may be operatively coupled to the external database, where the external database is configured to receive and hold a plurality of files that may include the formatted file. Further, the plurality of files held by the external database may include the template parameters and/or historical data (e.g., past formatted files of server template parameters, outdated server template parameters, and/or the like). Additionally, or alternatively, the engine may request a file from the external database. In such an embodiment, the external database may be configured to transfer the requested file (e.g., electronically, digitally, optically, and/or the like) to the engine. In some embodiments, the step of block 402 may be proceeded by a step of a block 312 as shown and described herein with respect to FIG. 3A.

In some embodiments, and as shown in block 404, the process flow 400 may include the step of extracting the generated server parameter values from the formatted file. For example, the formatted file may include a compressed version of the generated server parameter values. Prior to use, the engine may be configured to decompress (e.g., run a decompression algorithm that corresponds with how the formatted file was compressed) the formatted file. In some embodiments, once decompressed, the generated server parameter values of the formatted file may be extracted and may be used as inputs into a model, calculation, and/or the like.

In some embodiments, and as shown in block 406, the process flow 400 may include the step of retrieving the template parameter values from the external database. In some embodiments, the engine may be configured to use the template parameter values and/or the generated server parameter values as inputs to a model, calculation, and/or the like. Further, the external database may be configured to transfer the template parameter values (e.g., electronically, digitally, optically, and/or the like) to the engine.

In some embodiments, and as shown in block 408, the process flow 400 may include the step of comparing the template parameter values and the generated server parameter values to identify deviations between the template parameter values and the server parameter values. In some embodiments, a template parameter value of the template parameter values may have a corresponding server parameter value of the server parameter values (e.g., parameters that refer to the same metric such as an amount of memory used by an element of the server). Additionally, or alternatively, comparing the template parameter values and the generated server parameter values may include using an algorithm on the parameter values, using a mathematical operation on the parameter values, using a branch of statistical analysis (e.g., standard deviation, variance, Bayesian inference, ratio analysis, regression analysis, correlation coefficient, and/or the like) on the parameter values, using a branch of numerical analysis (e.g., absolute error, relative error, floating-point comparison, and/or the like) on the parameter values, and/or the like. Further, the engine may be configured to compare individual corresponding parameter values, sets of corresponding parameter values, and/or all the parameter values. In some embodiments, the deviated parameter values may be any of the generated server parameter values that may be comparatively different from a corresponding template parameter value.

In some embodiments, and as shown in block 410, the process flow 400 may include the step of creating the additional formatted file containing the deviated parameter values. In some embodiments, the deviated parameter values may use a large amount of memory resources. In such embodiments, an additional formatted file (e.g., a compressed file containing the same information using less memory resources) may be used to store the deviated server parameter values. In some embodiments, the additional formatted file may be generated by using a compression algorithm (e.g., text compression, lossless compression, lossy compression, run length encoding, dictionary coding, and/or the like) on the server parameter values. Further, the compression algorithm may be the same as the compression algorithm applied in the step of block 310 as shown and described herein with respect to FIG. 3A.

In some embodiments, and as shown in block 412, the process flow 400 may include the step of returning the additional formatted file. In some embodiments, the additional formatted file may be sent (e.g., electronically, optically, digitally, mechanically, and/or the like) for use in analysis by a processing device (e.g., an engine, a CPU, an AI model, an ML model, and/or the like). Further, a copy of the additional formatted file may be stored in the external database and/or an additional data repository for a temporary period of time and/or an indefinite period of time. In some embodiments, the step of block 412 may be followed by the step of block 314 as shown and described herein with respect to FIG. 3A.

The process flow 400 may include additional embodiments, such as any single embodiment or any combination of embodiments described herein. Although FIG. 4 shows example blocks of the process flow 400, in some embodiments, the process flow 400 may include additional blocks, fewer blocks, different blocks, or differently arranged blocks than those depicted in FIG. 4. Additionally, or alternatively, two or more of the blocks of the process flow 400 may be performed in parallel.

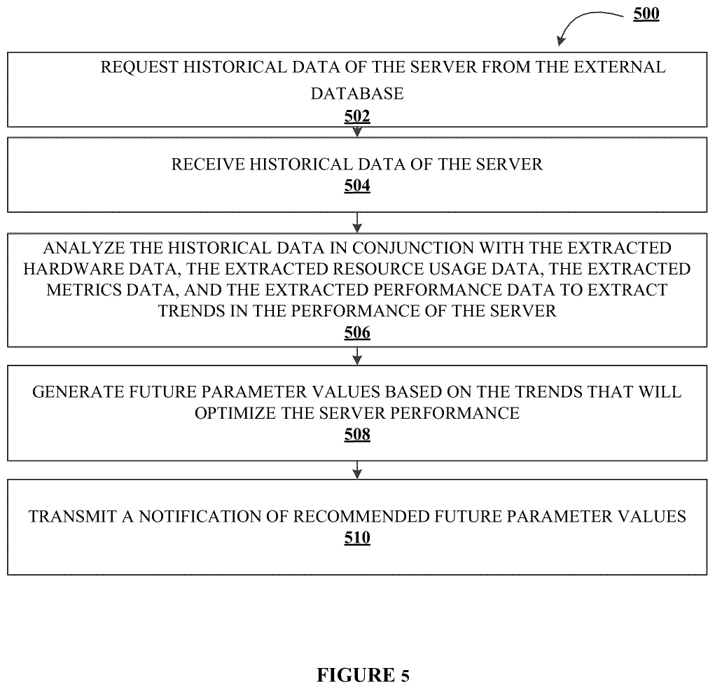

FIG. 5 illustrates a process flow 500 for AI-powered adaptable drift management for computer servers, in accordance with an embodiment of the invention. In some embodiments, a system (e.g., similar to one or more of the systems shown and described herein with respect to FIGS. 1A-1C) may perform one or more of the steps of process flow 500. For example, an AI-powered adaptable drift management system (e.g., similar to the system 130 shown and described herein with respect to FIG. 1A-1C) may perform the steps of process flow 500. In some embodiments, an artificial intelligence engine (e.g., such as the AI engine subsystem 200 as shown and described herein with respect to FIG. 2) may perform one or more of the steps of process flow 500.

In some embodiments, and as shown in block 502, the process flow 500 may include the step of requesting historical data of the server from the external database. In some embodiments, the external database may be configured to store a plurality of files that may include data related to previous configurations of the server (e.g., prior formatted files that include server parameters). Further, the external database may be configured to transfer (e.g., electronically, digitally, optically, and/or the like) the historical data to a recommendation engine (e.g., an AI and/or ML model configured to provide predictive analytics).

In some embodiments, and as shown in block 504, the process flow 500 may include the step of receiving historical data of the server. In some embodiments, the requested historical data may be transferred from the external database to the recommendation engine. Further, the recommendation engine may be configured to temporarily store the historical data for the duration of the analysis performed by the recommendation engine.

In some embodiments, and as shown in block 506, the process flow 500 may include the step of analyzing the historical data in conjunction with the extracted hardware data, the extracted resource usage data, the extracted metrics data, and the extracted performance data to extract trends in the performance of the server. In some embodiments, the recommendation engine may be configured to analyze the historical data in conjunction with the extracted data by using at least one numerical and/or statistical analysis technique (e.g., correlation analysis, predictive modeling, time series plots, histograms, correlation analysis, principal component analysis, clustering analysis, regression analysis, time series analysis, Monte Carlo simulations, optimization algorithms, and/or the like). Additionally, or alternatively, the recommendation engine may be configured to use the historical data in conjunction with the extracted data as inputs into an AI and/or ML model as a means of analysis for the data. Further, the historical data and/or extracted data may be adjusted (e.g., using data cleaning, data transformation, feature engineering, data reduction, and/or the like) prior to use as inputs to an AI and/or ML model.

In some embodiments, and as shown in block 508, the process flow 500 may include the step of generating future parameter values based on the trends that will optimize the server performance. In some embodiments, the analysis performed by the recommendation engine may yield insights into what set of parameters may best perform in a future time period. In such an embodiment, the recommendation engine may be configured to generate the set of future parameter values that will optimize the server performance. For example, the analysis of the historical data in conjunction with the extracted data may indicate that during a time of year there is an increased load on the memory resources of the server. The recommendation engine may be configured to generate a set of parameter values for the time of year that improves the server performance under an increased load on the memory resource of the server.

In some embodiments, and as shown in block 510, the process flow 500 may include the step of transmitting a notification of recommended future parameter values. In some embodiments, the notification may include an alert to a server administrator, an email alert to server engineers, a text message to server administrators, a document and/or file containing the set of recommended future parameter values, and/or the like. Further, a copy of the notification may be stored in a memory location. Additionally, or alternatively, the recommendation engine may be configured to send a further notification at a future time when the recommended future parameter values will best optimize the server performance.

The process flow 500 may include additional embodiments, such as any single embodiment or any combination of embodiments described herein. Although FIG. 5 shows example blocks of the process flow 500, in some embodiments, the process flow 500 may include additional blocks, fewer blocks, different blocks, or differently arranged blocks than those depicted in FIG. 5. Additionally, or alternatively, two or more of the blocks of the process flow 500 may be performed in parallel.

FIG. 6 illustrates a process flow 600 for AI-powered adaptable drift management for computer servers, in accordance with an embodiment of the invention. In some embodiments, a system (e.g., similar to one or more of the systems shown and described herein with respect to FIGS. 1A-1C) may perform one or more of the steps of process flow 600. For example, an AI-powered adaptable drift management system (e.g., similar to the system 130 shown and described herein with respect to FIG. 1A-1C) may perform the steps of process flow 600. In some embodiments, an artificial intelligence engine (e.g., similar to the AI engine subsystem 200 as shown and described herein with respect to FIG. 2) may perform some or all of the steps described in process flow 600.

In some embodiment, and as shown in block 602, the process flow 600 may include the step of inputting a combination of the template parameter values and the deviated parameter values on a test server. In some embodiments, the test server may be configured to receive a combination of parameters as inputs for how the server may function. Further, the test server may be a physical server configured to test server configurations. Additionally, or alternatively, the test server may be a computer simulation of a physical server. Further, a plurality of test servers may be employed to test combinations of parameters.

In some embodiments, and as shown in block 604, the process flow 600 may include the step of running the test server under the combination. In some embodiments, once the combination has been input to the test server, the test server may operate for a period of time under the combination. Additionally, or alternatively, the test server may be a computer simulation that simulates the performance of a physical server under the combination of server parameters. Further, the simulation may be performed a plurality of times to verify the results of the simulation.

In some embodiments, and as shown in block 606, the process flow 600 may include the step of monitoring the performance of the test server under the combination. In some embodiments, once the combination has been input to the test server, the test server may monitor (e.g., watch, record, and/or analyze metrics) its operation under the combination. Additionally, or alternatively, a secondary party (e.g., an AI model, a server developer, and/or the like) may monitor the performance of the test server under the combination. Further, monitoring the performance may include analyzing the results of a computer simulation that simulates the performance of a physical server under the combination of server parameters for any anomalous and/or any otherwise interesting results.

In some embodiments, and as shown in block 608, the process flow 600 may include the step of extracting hardware data, resource usage data, metrics data, and performance data for the test server under the combination. In some embodiments, once the combination has been input to the test server, the test server may operate to evaluate the performance of the test server under the combination. As the server operates, metrics of the performance of various aspects of the server may be recorded for use in analyzing the overall performance of the test server under the combination. Further, data of each element of the server may be extracted, transferred, and compiled into a singular location (e.g., a file, a memory location, a database, and/or the like). In some embodiments, the test server may be a computer simulation that simulates the performance of a physical server under the combination of server parameters and generates the necessary data (e.g., the hardware data, the resource usage data, the metrics data, and/or the performance data) for analyzing the behavior of the combination of server parameters.

In some embodiments, and as shown in block 610, the process flow 600 may include the step of generating an overall performance metric for the test server under the combination. In some embodiments, the performance of the combination may be encapsulated by an overall performance metric (e.g., each individual data element is similarly scaled (e.g., data normalization, feature scaling, and/or the like), is multiplied by a weight value (e.g., an internal metric of the relative importance of that data element), included in a weighted sum, and/or other mathematical operations) of the hardware data, resource usage data, metrics data, and/or performance data of the test server under the combination. Further, this overall performance metric may be used to determine if a combination of parameters yields an improved performance of a server over another combination of parameters.

In some embodiments, and as shown in block 612, the process flow 600 may include the step of comparing the overall performance metric against a previous overall performance metric. In some embodiments, if the overall performance metric is higher than the previous overall performance metric, the overall performance metric yields an improved server performance over the previous overall performance metric. In some embodiments, if the overall performance metric is lower than the previous overall performance metric, the overall performance metric yields an improved server performance over the previous overall performance metric.

In some embodiments, and as shown in block 614, the process flow 600 may include the step of storing the better performing of the overall performance metric and the previous overall performance metric. In some embodiments, a combination of parameters will yield a better overall performance metric compared to another combination of parameters. In such an embodiment, the combination of parameters with the better overall performance metric will be the preferred set of parameters for a server configuration.

In some embodiments, and as shown in block 616, the process flow 600 may include the step of repeating for a new combination of the template parameter values and the deviated parameter values. In some embodiments, once all necessary combinations of parameters have been simulated, the step of block 616 may be followed by the step of block 318 as shown and described herein with respect to FIG. 3B. In some embodiments, the process flow 600 may perform some or all of the analysis of the step of block 316 as shown and described herein with respect to FIG. 3A.

The process flow 600 may include additional embodiments, such as any single embodiment or any combination of embodiments described herein. Although FIG. 6 shows example blocks of the process flow 600, in some embodiments, the process flow 600 may include additional blocks, fewer blocks, different blocks, or differently arranged blocks than those depicted in FIG. 6. Additionally, or alternatively, two or more of the blocks of the process flow 600 may be performed in parallel.

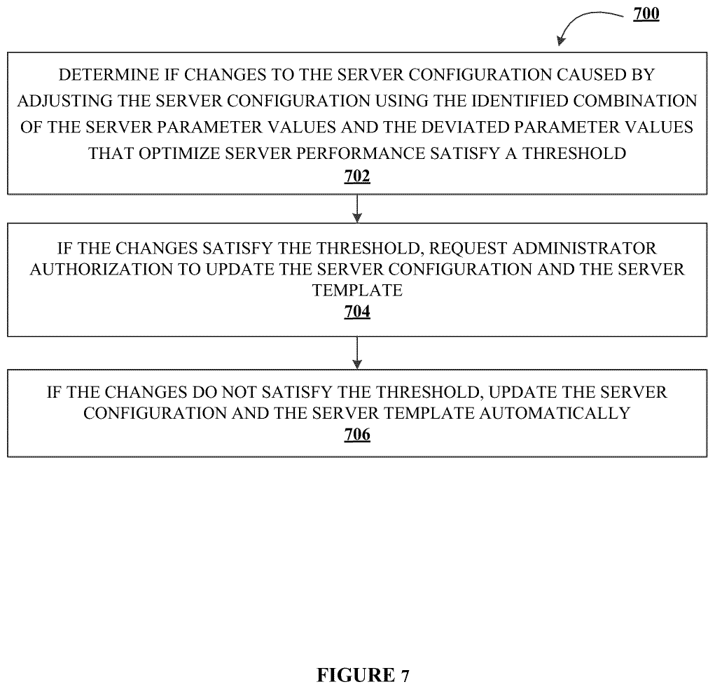

FIG. 7 illustrates a process flow 700 for AI-powered adaptable drift management for computer servers, in accordance with an embodiment of the invention. In some embodiments, a system (e.g., similar to one or more of the systems shown and described herein with respect to FIGS. 1A-1C) may perform one or more of the steps of process flow 700. For example, an AI-powered adaptable drift management system (e.g., similar to the system 130 shown and described herein with respect to FIG. 1A-1C) may perform the steps of process flow 700. In some embodiments, an artificial intelligence engine (e.g., similar to the AI engine subsystem 200 as shown and described herein with respect to FIG. 2) may perform some or all of the steps described in process flow 700.

In some embodiments, and as shown in block 702, the process flow 700 may include the step of determining if changes to the server configuration caused by adjusting the server configuration using the identified combination of the server parameter values and the deviated parameter values that optimize server performance satisfy a threshold. In some embodiments, a server may include a threshold for adjustments to the configuration of the server. Further, the threshold may be configured to prevent significant updates to the server's configuration from automatically occurring without authorization from a server administrator. Additionally, or alternatively, the threshold may be set based on the needs of the server, AI analysis of server updates, prior incidents involving server updates, insights from server developers, and/or the like. In some embodiments, the changes to the server configuration may be encapsulated by an overall metric (e.g., each individual parameter has a percent changed calculated, is multiplied by a weight value, included in a weighted sum, and/or other mathematical operations) for comparison against the threshold. In some embodiments, the step of block 702 may be proceeded by the step of block 318 as shown and described herein with respect to FIG. 3B.

In some embodiments, and as shown in block 704, the process flow 700 may include the step of requesting, if the changes satisfy the threshold, administrator authorization to update the server configuration and the server template. In some embodiments, the overall metric of the changes may be above the threshold. In such an embodiment, the updates to the server configuration and the server template may not be incorporated unless the updates receive approval by an authorized administrator. In some embodiments, the overall metric of the changes may be below the threshold. In such an embodiment, the updates to the server configuration and the server template may not be incorporated unless the updates receive approval by an authorized administrator. Additionally, or alternatively, in the event the overall metric is equal to the threshold, the updates to the server configuration and the server template may not be incorporated unless the updates receive approval by an authorized administrator. In some embodiments, the step of block 704 may be followed by the step of block 320 as shown and described herein with respect to FIG. 3B.

In some embodiments, and as shown in block 706, the process flow 700 may include the step of updating, if the changes do not satisfy the threshold, the server configuration and the server template automatically. In some embodiments, the overall metric of the changes may be above the threshold. In such an embodiment, the updates to the server configuration and the server template may be incorporated without the updates receiving approval by an authorized administrator. In some embodiments, the overall metric of the changes may be below the threshold. In such an embodiment, the updates to the server configuration and the server template may be incorporated without the updates receiving approval by an authorized administrator. Additionally, or alternatively, in the event the overall metric is equal to the threshold, the updates to the server configuration and the server template may be incorporated without the updates receiving approval by an authorized administrator. In some embodiments, the step of block 706 may be followed by the step of block 320 as shown and described herein with respect to FIG. 3B.

The process flow 700 may include additional embodiments, such as any single embodiment or any combination of embodiments described herein. Although FIG. 7 shows example blocks of the process flow 700, in some embodiments, the process flow 700 may include additional blocks, fewer blocks, different blocks, or differently arranged blocks than those depicted in FIG. 7. Additionally, or alternatively, two or more of the blocks of the process flow 700 may be performed in parallel.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for AI-powered adaptable drift management for computer servers, the system comprising:
at least one memory device with computer-readable program code stored thereon;
at least one processing device operatively coupled to the at least one memory device, wherein executing the computer-readable code is configured to cause the at least one processing device to:
retrieve a server template of a server from the at least one memory device;
extract template parameter values from the server template;
extract hardware data, resource usage data, metrics data, and performance data for a current server configuration of the server;
generate server parameter values from the extracted hardware data, the extracted resource usage data, the extracted metrics data, and the extracted performance data or via feature engineering of the extracted hardware data, the extracted resource usage data, the extracted metrics data, and the extracted performance data;
convert the generated server parameter values into a formatted file;
transmit the formatted file;
receive an additional formatted file containing deviated parameter values;
analyze server performance under combinations of the deviated parameter values and the template parameter values;
identify a combination of the server parameter values and the deviated parameter values that optimizes server performance;
adjust the server configuration using the identified combination of the server parameter values and the deviated parameter values that optimize server performance;
update the server template with the identified combination of the server parameter values and the deviated parameter values that optimizes server performance;
transmit the updated server template; and
transmit a report of the updates to the server template.

2. The system of claim 1, wherein an external database is configured to receive and store the formatted file, and wherein the external database is operatively coupled to an engine configured to:
receive the formatted file from the external database;
extract the generated server parameter values from the formatted file;
retrieve the template parameter values from the external database;
compare the template parameter values and the generated server parameter values to identify deviations between the template parameter values and the server parameter values;
create the additional formatted file containing the deviated parameter values; and
return the additional formatted file.

3. The system of claim 2, comprising an AI model configured to:
request historical data of the server from the external database;
receive historical data of the server;
analyze the historical data in conjunction with the extracted hardware data, the extracted resource usage data, the extracted metrics data, and the extracted performance data to extract trends in the performance of the server;
generate future parameter values based on the trends that optimize the server performance; and
transmit a notification of recommended future parameter values.

4. The system of claim 2, wherein the external database is configured to receive the updated server template and update the current template parameter values with the updated template parameter values of the updated server template.

5. The system of claim 1, comprising an AI model configured to:
input a combination of the template parameter values and the deviated parameter values on a test server;
run the test server under the combination;
monitor the performance of the test server under the combination;
extract hardware data, resource usage data, metrics data, and performance data for the test server under the combination;
generate an overall performance metric for the test server under the combination;
compare the overall performance metric against a previous overall performance metric;
store the better performing of the overall performance metric and the previous overall performance metric; and
repeat for a new combination of the template parameter values and the deviated parameter values.

6. The system of claim 5, wherein the AI model is configured to transmit and receive instructions from a DevOPs tools and to automate DevOPs processes.

7. The system of claim 1, wherein executing the computer-readable code is configured to cause the at least one processing device to, before adjusting the server configuration:
determine if changes to the server configuration caused by adjusting the server configuration using the identified combination of the server parameter values and the deviated parameter values that optimize server performance satisfy a threshold;
if the changes satisfy the threshold, request administrator authorization to update the server configuration and the server template; and
if the changes do not satisfy the threshold, update the server configuration and the server template automatically.

8. A computer program product for AI-powered adaptable drift management for computer servers, the computer program product comprising a non-transitory computer-readable medium comprising code causing an apparatus to:
retrieve a server template of a server;
extract template parameter values from the server template;
extract hardware data, resource usage data, metrics data, and performance data for a current server configuration of the server;
generate server parameter values from the extracted hardware data, the extracted resource usage data, the extracted metrics data, and the extracted performance data or via feature engineering of the extracted hardware data, the extracted resource usage data, the extracted metrics data, and the extracted performance data;
convert the generated server parameter values into a formatted file;
transmit the formatted file;
receive an additional formatted file containing deviated parameter values;
analyze server performance under combinations of the deviated parameter values and the template parameter values;
identify a combination of server parameter values and deviated parameter values that optimizes server performance;
adjust the server configuration using the identified combination of the server parameter values and the deviated parameter values that optimize server performance;
update the server template with the identified combination of the server parameter values and the deviated parameter values that optimizes server performance;
transmit the updated server template; and
transmit a report of the updates to the server template.

9. The computer program product of claim 8, wherein an external database is configured to receive and store the formatted file, and wherein the external database is operatively coupled to an engine configured to:
receive the formatted file from the external database;
extract the generated server parameter values from the formatted file;
retrieve the template parameter values from the external database;
compare the template parameter values and the generated server parameter values to identify deviations between the template parameter values and the server parameter values;
create the additional formatted file containing the deviated parameter values and;
return the additional formatted file.

10. The computer program product of claim 9, comprising an AI model configured to:
request historical data of the server from the external database;
receive historical data of the server;
analyze the historical data in conjunction with the extracted hardware data, the extracted resource usage data, the extracted metrics data, and the extracted performance data to extract trends in the performance of the server;
generate future parameter values based on the trends that will optimize the server performance; and
transmit a notification of recommended future parameter values.

11. The computer program product of claim 9, wherein the external database is configured to receive the updated server template and update the current template parameter values with the updated template parameter values of the updated server template.

12. The computer program product of claim 8, comprising an AI model configured to:
input a combination of the template parameter values and the deviated parameter values on a test server;
run the test server under the combination;
monitor the performance of the test server under the combination;
extract hardware data, resource usage data, metrics data, and performance data for the test server under the combination;
generate an overall performance metric for the test server under the combination;
compare the overall performance metric against a previous overall performance metric;
store the better performing of the overall performance metric and the previous overall performance metric; and
repeat for a new combination of the template parameter values and the deviated parameter values.

13. The computer program product of claim 12, wherein the AI model is configured to transmit and receive instructions from a DevOPs tools and to automate DevOPs processes.

14. The computer program product of claim 8, wherein the code causes the apparatus to, before adjusting the server configuration:
determine if changes to the server configuration caused by adjusting the server configuration using the identified combination of the server parameter values and the deviated parameter values that optimize server performance satisfy a threshold;
if the changes satisfy the threshold, request administrator authorization to update the server configuration and the server template; and
if the changes do not satisfy the threshold, update the server configuration and the server template automatically.

15. A method for AI-powered adaptable drift management for computer servers, the method comprising:
retrieving a server template of a server;
extracting template parameter values from the server template;
extracting hardware data, resource usage data, metrics data, and performance data for a current server configuration of the server;
generating server parameter values from the extracted hardware data, the extracted resource usage data, the extracted metrics data, and the extracted performance data or via feature engineering of the extracted hardware data, the extracted resource usage data, the extracted metrics data, and the extracted performance data;
converting the generated server parameter values into a formatted file;
transmitting the formatted file;
receiving an additional formatted file containing deviated parameter values;
analyzing server performance under combinations of the deviated parameter values and the template parameter values;
identifying a combination of server parameter values and deviated parameter values that optimizes server performance;
adjusting the server configuration using the identified combination of the server parameter values and the deviated parameter values that optimize server performance;
updating the server template with the identified combination of the server parameter values and the deviated parameter values that optimizes server performance;
transmitting the updated server template; and
transmitting a report of the updates to the server template.

16. The method of claim 15, wherein an external database is configured to receive and store the formatted file, and wherein the external database is operatively coupled to an engine configured for:
receiving the formatted file from the external database;
extracting the generated server parameter values from the formatted file;
retrieving the template parameter values from the external database;
comparing the template parameter values and the generated server parameter values to identify deviations between the template parameter values and the server parameter values;
creating the additional formatted file containing the deviated parameter values; and
returning the additional formatted file.

17. The method of claim 16, comprising an AI model configured for:
requesting historical data of the server from the external database;
receiving historical data of the server;
analyzing the historical data in conjunction with the extracted hardware data, the extracted resource usage data, the extracted metrics data, and the extracted performance data to extract trends in the performance of the server;
generating future parameter values based on the trends that will optimize the server performance; and
transmitting a notification of recommended future parameter values.

18. The method of claim 16, wherein the external database is configured for receiving the updated server template and updating the current template parameter values with the updated template parameter values of the updated server template.

19. The method of claim 15, comprising an AI model configured for:
inputting a combination of the template parameter values and the deviated parameter values on a test server;
running the test server under the combination;
monitoring the performance of the test server under the combination;
extracting hardware data, resource usage data, metrics data, and performance data for the test server under the combination;
generating an overall performance metric for the test server under the combination;
comparing the overall performance metric against a previous overall performance metric;
storing the better performing of the overall performance metric and the previous overall performance metric; and
repeating for a new combination of the template parameter values and the deviated parameter values.

20. The method of claim 8, wherein the method comprises, before adjusting the server configuration:
determining if changes to the server configuration caused by adjusting the server configuration using the identified combination of the server parameter values and the deviated parameter values that optimize server performance satisfy a threshold;
requesting, if the changes satisfy the threshold, administrator authorization to update the server configuration and the server template; and
updating, if the changes do not satisfy the threshold, the server configuration and the server template automatically.
